(19) United States
(12) Patent Application Publication
(10) Pub. No.: US 2003/0101227 A1
(43) Pub. Date: May 29, 2003

(54) Message collaborator

(76) Inventor: Alan Walter Fink, Salt Lake City, UT (US)

Correspondence Address: Alan W. Fink, 8131 Miranda LN, Sandy, UT, 84093, US

(21) Appl. No.: 09/996,530

(22) Filed: Nov. 28, 2001

(51) Int. Cl. G06F 15/16

(52) U.S. Cl. 709/207

(57) ABSTRACT

A message collaborator system and method establishes a relationship with more than one sender and a recipient. Directives are contained in the profile defining each of the relationships and how information is to be filtered or established into or out of a message. Rules are provided for collaborating all of these profiles in order to pull content from multiple sources remotely or from local databases containing content from the more than one sender, collecting the content into a single, comprehensive message and then delivering the single, comprehensive message to the recipient.

### BACKGROUND OF THE INVENTION

The present invention relates, in general, to mass communication of a message from multiple sources to various portions of a large audience. More particularly, the invention collaborates information from multiple sources along with the sources' preferences and recipients' preferences and generates and delivers a unique, distinct, comprehensive message containing information individualized or targeted to the recipient and containing information from more than one source.

The rise of the Internet has led to a mass communication problem where a multitude of vendors are all trying to vie for the attention of a user who may or may not want the information provided by any given vendor. This onslaught of information, colloquially called SPAM, bombards the recipient from multiple sources at unwanted times, in unwanted quantities, and in invasive ways. This method of communicating information to recipients creates several problems at all stages of the mass communication process. The vendor or sender must maintain extensive databases and needs to rely on filtering mechanisms individually designed for targeted locations or audiences, causing extensive need for IT resources. The recipients that receive the e-mail often have files cluttering their systems of unread e-mails that users simply move to trash or, in the worst case for vendors, ignore altogether. The recipient must filter through all of these messages, often leading to angered recipients who must contact each of the senders to discontinue their solicitation if they had previously approved the delivery of messages or, at worst, users who simply disregard all messages not from known, friendly sources like family, preferred vendors and the like. Overwhelmed users often become frustrated at the SPAM received from senders at a certain e-mail account and, in frustration, leave the service providing the e-mail account to establish another, less known user name.

Often the power to deliver messages to a large database of e-mail addresses is abused by companies to gain new recipients and close sales. Methods range from automated email harvesting (program agent's that walk the internet opening web pages and newsgroups looking for email addresses), buying “SPAM” lists outright for a few hundred dollars, to conglomerates that obtain mailing lists through various arrangements with other conglomerates. The recipient often becomes bombarded with unwanted e-mails or SPAM because there are no good mechanisms for a recipient to control receipt of various vendors' messages. A recipient can individually subscribe or unsubscribe to/from an individual vendor by wading through the messages investing personal time to send an unsubscribe email or visit the web site of the intruding message to remove their name from the list. In the most complex variation, a sender targets specific content along with paid advertisements to individual recipients according to their likes and dislikes, habits, etc.

In all of these methods of mass communication (as summarized in FIGS. 3, 4, and 5), a sender organizes content into a message, including information from any paid advertisers, and delivers a message to an audience and the user must choose whether to accept the information. In the case of TV or radio, the user must change the channel if he does not like the content delivered by a given sender. On the Internet, the user must unsubscribe or delete any message by any sender that he does not like. Additionally, in all of these methods, each sender must establish and maintain his own database and rules for delivering messages to targeted audiences. In the case of maintaining user profiles, each sender must maintain the tools and mechanisms for tracking user profiles (remote cookies and local recipient profiles). This requires extensive resources (software programmers, IT professionals, marketing teams, expensive storage systems & etc) that only large companies can afford on the scale necessary for reaching a large number of recipients.

What is needed is a method—a clearinghouse—that is robust and clever enough to maintain relationships with multiple vendors, have access to the content for each of these multiple vendors, maintain a relationship with a recipient or multiple recipients and maintain relationships from each vendor to each of it's recipients, and then provide a unique, distinct, and comprehensive targeted message for delivery to each recipient that pulls content from more than one vendor and delivers this new, personalized message to each individual recipient. The disclosed invention provides a system that allows a plurality of small companies or individuals to do targeted delivery of content to multiple recipients without the requirement of specialty IT staff, storage, and marketing resources normally required for this type of communication. Additionally, the invention collaborates the information from the multiple sources and provides a unique and distinct comprehensive message to the recipient so the recipient is not bombarded with multiple messages that are less likely to be perused. The formulation of the comprehensive message along with its content and delivery schedule will be determined in accordance with all of the following relationships: vendor to message collaborator; vendor to recipient; recipient to message collaborator; and possibly vendor to vendor. The invention provides a means for vendors, independent of their technical resources and relationship to one another, to establish a means of mass communicating their collective content to a wide, intermixed, and targeted audience, while also providing the recipient independent control of his distinct message.

### BRIEF DESCRIPTION OF THE DRAWINGS

FIG. 1 illustrates a computer system, connected to the Internet, wherein the computer system is capable of collecting or displaying information to or from a user of the system. This information can be relayed to another user through the worldwide Internet network that is connected using the TCP/IP protocol. This figure is then extended to describe a possible embodiment of this Invention.

FIG. 2 demonstrates the many to many relationships between the members of a database held and managed by this Invention. In addition, it describes a possible message process pipeline to collect and process data.

FIG. 3 demonstrates a conventional mass communication system;

FIG. 4 demonstrates a conventional method of an e-mail broadcast system;

FIG. 5 demonstrates the SPAM effect of the prior art methods of mass communication, particularly e-mail.

FIG. 6 is a high level depiction of a message collaborator according to one embodiment.

FIG. 7 is a detailed look at a message collaborator as it processes many rules in the processing stage that customize and personalize a unique message for a recipient.

FIG. 8 demonstrates examples of profile information for a sender, recipient, and outside source of related information.

FIG. 9 demonstrates the ability of the collaborator to generate a distinct and unique message for each recipient.

FIG. 10 demonstrates the dynamic nature of various relationships between two senders and a recipient.

FIG. 11 demonstrates possible process flow steps of a message collaborator according to one embodiment of the invention.

FIG. 12 shows an illustration of a collaborated message.

FIG. 13 shows more details of a single message block within a collaborated message that has content derived from various sources.

### DETAILED DESCRIPTION OF THE DRAWINGS

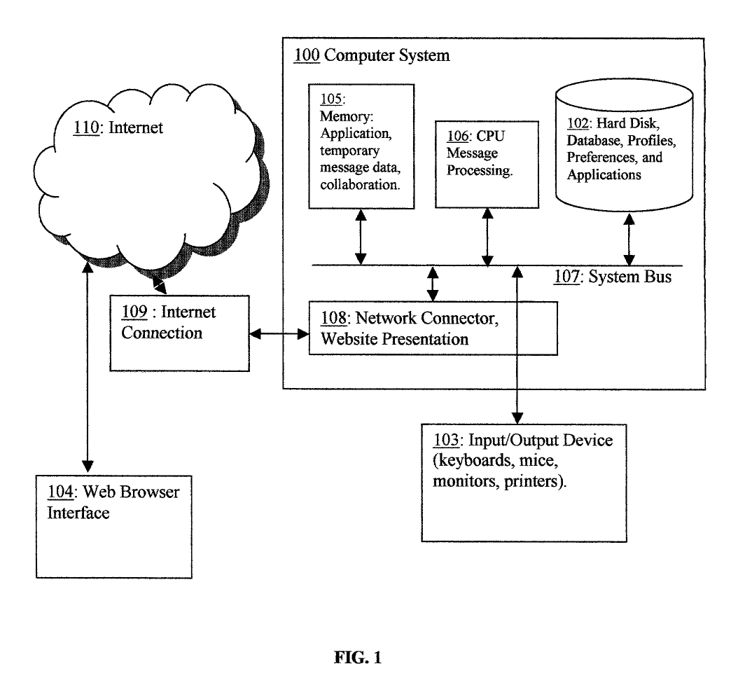

FIG. 1 illustrates a block diagram of a computer system 100 capable of managing information about people and the relationships along with information that is shared between them. Information and relationships are stored in a database housed on the computer system disk 102. The information is collected and maintained primarily through computer generated input/output devices 103 that can be manipulated via the World Wide Web (WWW) and a Web Browser 104. An application that is loaded into memory 105 and processed with the onboard central processing unit (“CPU”) 106 can analyze the data in the database and act upon the relationships and preferences described in the data. As the data is processed, it can be formed into an electronic message that is suitable for transmission on the Internet 110. In order for such a message to be sent to the Internet, it must be encoded for the TCP/IP protocol and sent to the local network interface 108 and passed through an Internet Connection 109. Once the message is on the Internet, it is delivered to a destination utilizing the TCP/IP protocol 110.

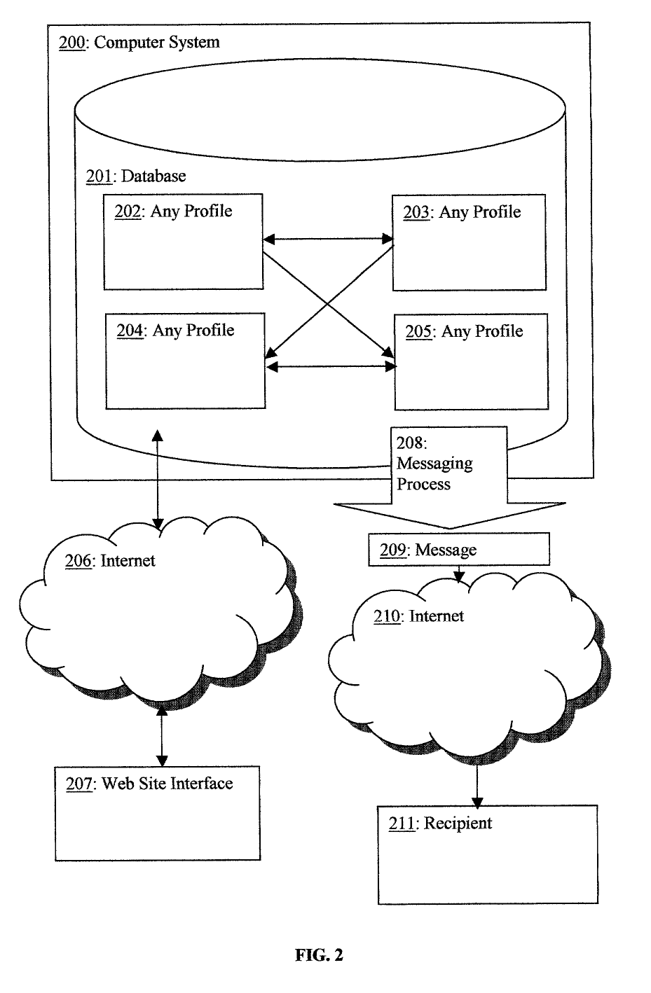

FIG. 2 demonstrates one embodiment of the present invention where the computer system 200 collects profiles for any given individual member into the database 201. Such profiles are established in a many to many arrangement where any one profile can establish a distinct relationship to each of many other profiles, and, concurrently, any of these other profiles can establish a distinct relationship with each of any other number of profiles including the original profile. In the diagram, the single member 202 has a relationship with members 203 and 205 where members 203 and 205 may be member 202's student, employee, or customer (or other such relationship). At the same time, the single member 203 (who is also a member of member 202's member base) has a relationship with members 202 and 204 where members 202 and 204 may be member 203's friend, brother, customer, etc. Finally, members 204 and 205 are members of each other's member base (i.e. friends, siblings, etc.). In summary, members 203 and 205 are recipients of member 202; and, members 202 and 204 are recipients of member 203; and, members 204 and 205 are recipients of each other. In the message collaboration process, four messages would be sent. The message to member 202 would have content from member/sender 203. The message to member 203 would have content from member/sender 202. The message to member 204 would have content from members/senders 203 and 205. And, the message to member 205 would have content from members/senders 202 and 204. Essentially, many of these relationships correspond directly to real-life situations. In addition, these relationships each contain many elements of information such as location of member, relationship type, categorization, grouping, histories, sex, member interests, who or what entity will be allowed to create a relationship, what rating of information it will accept (i.e. “G”, “R”, “X”), etc. The profiles themselves are established by various means such as website registration, file upload (by a qualified members only listing), one member entering the relationship to another member, etc. Information is typically entered via a website interface 207 and the Internet 206. Specific parameters are required in such data entry to the system forcing a qualified relationship between the members (202, . . . 205). Such qualified relationship is enforced by requiring that either (a) the Recipient provides their own information to opt-in for a relationship or (b) the Sender provides enough information to prove a pre-existing relationship with that Recipient. For example, Widgets, Inc. may be required to provide a member number and a telephone number or a full name & address along with a correct email address, or a private account number. In the event that Widgets Inc., attempted to upload unqualified Recipients, and complaints resulted, Widgets, Inc.'s profile would immediately be disabled until a resolution had been met.

The website interface can allow any member to enter and manipulate their relationship information that describes a relationship. All Four profiles 202, 203, 204 & 205 are considered Senders or Owners because they have profiles that are defined as Recipients or Members to the respective profile. That is, profile 202 is a Sender/Owner to profiles/recipients/members 203/205. And, profile 203 is a Sender/Owner to profiles/recipients/members 202/204. And, 204 and 205 are senders to each other. As such, each Sender has a right to communicate with its respective Members/Recipients. Using this embodiment, the Message Collaborating process 208 can collect and create a unique, distinct, collaborative message 209 for each Recipient member based upon the relationships and information in the Database 201. Such a collaborative message may be delivered via the Internet 210 to the actual Recipient 211. Any given Member will receive his/her own unique and distinct collaborative message established by a single collaborative message process triggered by a triggering event such as time common to ALL Senders collectively (even though each Sender is able to select its recipients via its own established relationships with various recipients).

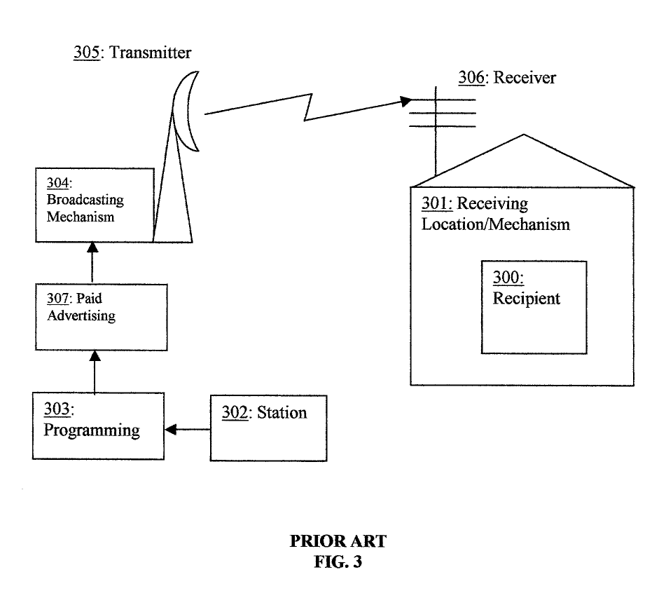

FIG. 3 demonstrates a conventional mass communication system that delivers a single message from a single sender to multiple recipients. A recipient 300, by choosing a station, such as ABC on a radio, a television set or other receiving mechanism 301 for instance, selects a trusted source for receiving information. Concurrently, the owner of ABC station 302 has programmed or scheduled content 303 along with paid advertising and/or sponsored information 307 that is being delivered by a broadcasting mechanism 304. In this conventional messaging, as in all typical mass communication messaging, the single sender 302 controls the content, scheduling, and the actual audience. The paid advertisers cannot decide to whom the message will be delivered, nor can the paid advertiser limit the delivery of its advertisement interactively and independently of the sender without negotiating each piece of its advertisement distribution—when, which localities, etc. There is no mechanism that allows the paid advertiser to eliminate categories of recipients as the sender jealously guards and protects its audience and distribution profiles. To solidify, the advertisers have no ability to say that individual recipient A or any first person on a sender's list will receive the message but individual recipient B or any second person on the sender's list will not. Essentially, the advertiser does not have the ability to be a sender with dynamic and individual control over sender's recipients. Ultimately, all recipients targeted by the mass mailer receive the same message without distinction.

The owner of the ABC station 302 broadcasts information through methods of mass communication such as satellite, cable, Internet, & etc. In this Figure, the information is broadcast from a transmitter 305 using amplitude or frequency modulated air waves where the message is sent to a receiver 306 and communicated via local wiring to the actual receiver and Recipient 301/300. Alternatively, messages may be communicated over a local area network, cable, Internet, or other viable mass communication means. In the case of satellite broadcast, the information delivered corresponds with a given station for a given market or locality. On the internet, lower level of demographics may be targeted by the sender, but any advertiser cannot pick and choose recipients according to its own demographics, but must use demographics established by the sender that owns or has a relationship with the audience, or list of recipients.

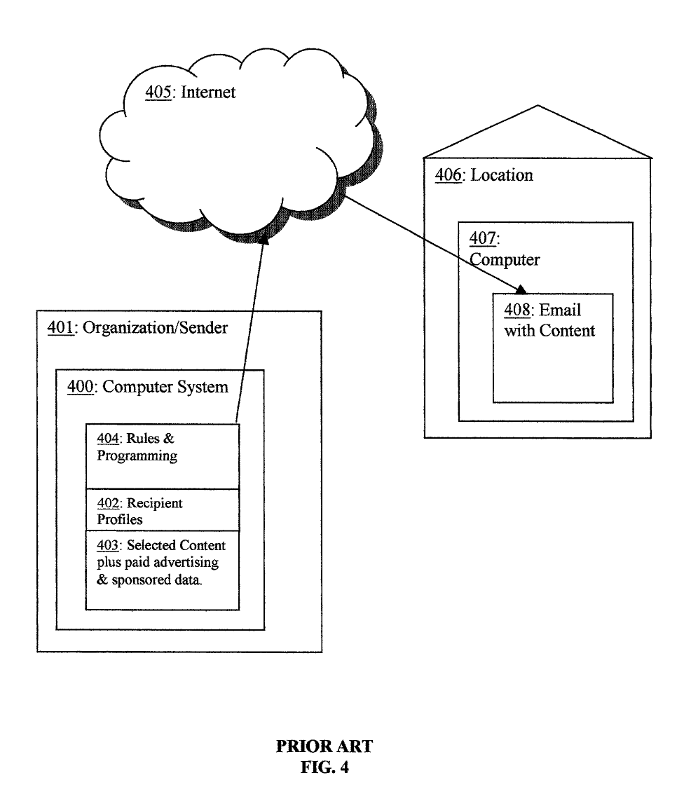

As the Internet has become more robust, the conventional methods of mass communications have become more advanced. FIG. 4 demonstrates a prior art method of receiving and delivering mass communication messages to an audience or recipient that has become an order of magnitude more substantial and variably controlled. A computer system or server 400 for an organization 401 houses a database of recipient profiles 402 and selected content 403. The recipient profiles 402 can be established, for example, by the Recipient subscribing via website or by the Sender creating a profile due to an existing relationship, like a credit card applicant. A list of rules and processes 404 are developed for delivering various portions of the content 403 to the respective recipients according to their profiles 402. These rules of delivery may include various filter mechanisms to select recipients based on profile categories. For instance, the owner 401 can program the server to deliver an updated message every day to all recipients containing any headlines for the day along with paid advertisements. Once the content from the organization along with any included paid advertisements is determined by the sender and is prepared by the sender it is delivered to a recipient's location 406 via a mass communication means such as the Internet 405. It is important to note that any advertiser placing an ad with the sender ultimately must rely on the sender's relationship with the sender's customers to reach the audience and cannot target its own customers without establishing its own broadcasting schema. Furthermore, each recipient receives substantially the same message.

The recipient's computer 407 receives the e-mail 408 and the recipient is able to read the content from the organization or sender. In this method, the organization or sender may provide paid advertisements to sponsors that the sender organizes and provides as part of its content. Once the advertisement content has been provided to the sender, the sender has control over its distribution and layout and does not allow the paid advertiser to interactively manipulate the distribution boundaries, content, location of ad placement, audience targeted, & etc.

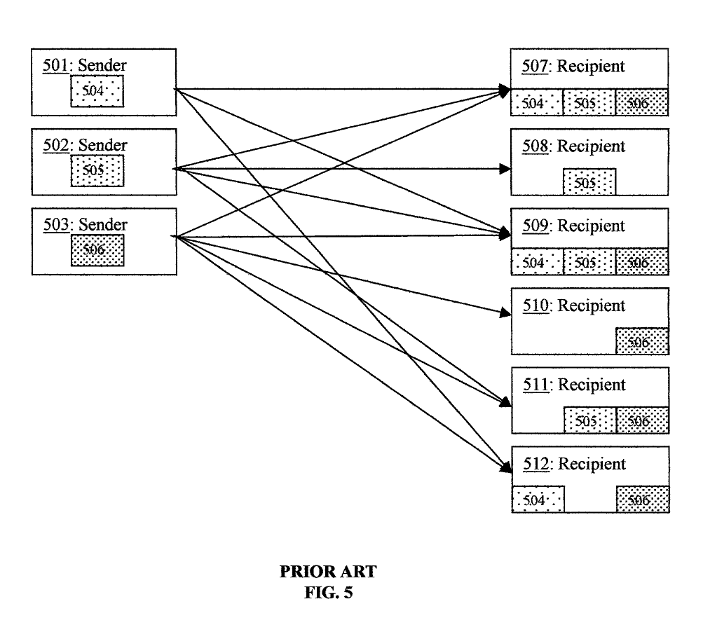

FIG. 5 demonstrates how typical broadcast communication looks from multiple senders 501-503 to multiple recipients 507-512. Each sender determines to send out a common message of content to various recipients where the recipients are chosen according to their profiles. For instance, sender 501 creates message 504 that gets delivered to recipients 507, 509 and 512; sender 502 creates message 505 that is sent to recipients 507, 508, 509, and 511; and sender 503 creates message 506 that is sent to recipients 507, 509, 510, 511, and 512. In cases where multiple messages, each from a different vendor, are received, the user is bombarded with multiple e-mails from multiple vendors 507, 509, 511 and 512 and each vendor must maintain its own database of recipient profiles and rules for distribution. In this very simplified example, one can see recipients receiving upwards of three separate messages from only three senders. In the real world, typical email accounts are bombarded with upwards of several hundred SPAM messages each day.

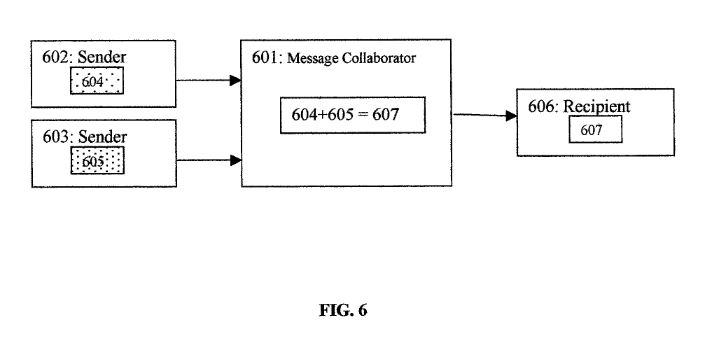

FIG. 6 demonstrates the concept of the Message Collaborator Invention in its broadest form. The message collaborator engine 601 receives content 604 and 605 from multiple sources 602 and 603 respectively. The content can be individually directed by each of the senders, whether a large conglomerate or a small entity—the vendor or individual with the content has interactive control over where, when, to whom and how its content will be distributed. This content is then merged into a single message 607 by the message collaborator and formatted for the Recipient 606 according to his/her preferences. The new personalized collaborative and unique message 607 (with unique content pulled from both senders 602 & 603) is then delivered to the recipient 606. The senders 602 and 603 need not have any relationship to one another and may work independently and interactively to identify their target audiences and distribution rules even though their message is collaborated with another message from another sender before being delivered to the recipient.

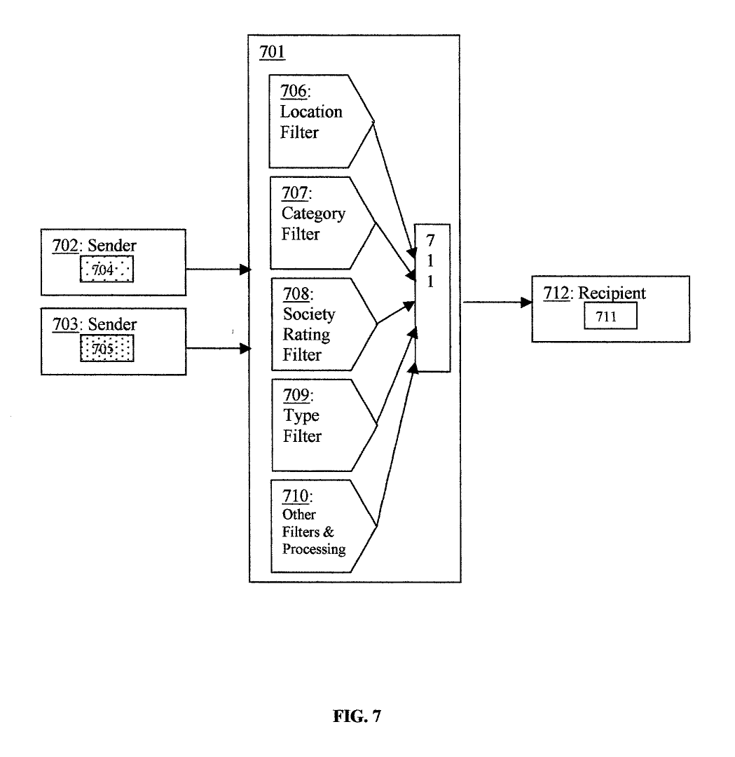

FIG. 7 demonstrates a message collaborator engine 701 expanded in further detail from FIG. 6. The message collaborator engine 701 maintains a system of rules 706-710 for collaborating and delivering the content from multiple vendors 702 and 703 into a single comprehensive and distinct message 711 containing content 704 and 705 provided by the senders 702 and 703 that is sent to a recipient 712. The rules for creating and delivering the messages are dependent on maintained profiles that represent the dynamic relationship between the message collaborator engine, the senders, and the recipients. Relationship information is maintained in several permutations. First, the message collaborator 701 maintains a relationship with the Senders 702, 703. Second, the message collaborator 701 maintains a relationship with the recipient 712. Finally, the senders 702, 703 may have an established relationship with the recipient 712. The senders 702 and 703 have an established ability to communicate directly with each of their recipients 712 with whom they have independently established a relationship. Such relationship management actually qualifies the message collaborator as a Customer Relationship Management tool that allows a company to communicate regularly with its employees, a church with its members, a store with its customers, or a member of a family with his siblings. The message collaborator combines all of the messages from the company, church, store, and brother into one comprehensive message that is easier to read, save, and expand into details according to the recipient's needs and desires contained in the recipient's profile. The sender's privacy and the recipient's privacy is protected because none of the senders are necessarily aware of the other sender's content and none of the recipients are necessarily aware of who the other recipients may be nor with whom other senders have a relationship. Each message is personal and customized specifically for the Recipient enhancing value and privacy. Thus, the message collaborator according to one embodiment is a mass communications technology that allows many senders to send a custom, comprehensive message to many recipients on a large scale. The message collaborator provides a single, comprehensive message for each individual according to the collective relationships utilized to create the single message. A sender can prepare his content to be delivered to a large audience, but each individual in that audience will ultimately receive a unique message. This is in stark contrast to conventional methods where advertisers provide content to a sender, wherein the sender collects the advertisements along with proprietary content owned by the sender and then distributes this same message to a large population according to broad demographics. The present invention allows multiple senders to independently work on content to be distributed along with what audiences or individuals to target. Then, the collaborator creates unique messages individually targeted for each recipient according to relationship and preferences that contains information from multiple sources.

Senders 702 and 703 do not necessarily have any relationship or knowledge of the others' existence (i.e. there is no implied relationship between 702 and 703). Nor will the senders necessarily be aware of any relationships between the message collaborator and the recipient. Because of the ability to target specific individuals and demographics, any sender, whether an individual or a large entity can target other individuals or groups of recipients based on selected demographics, locality, age group, gender, likes, dislikes, shopping habits, or any other class defined by the sender.

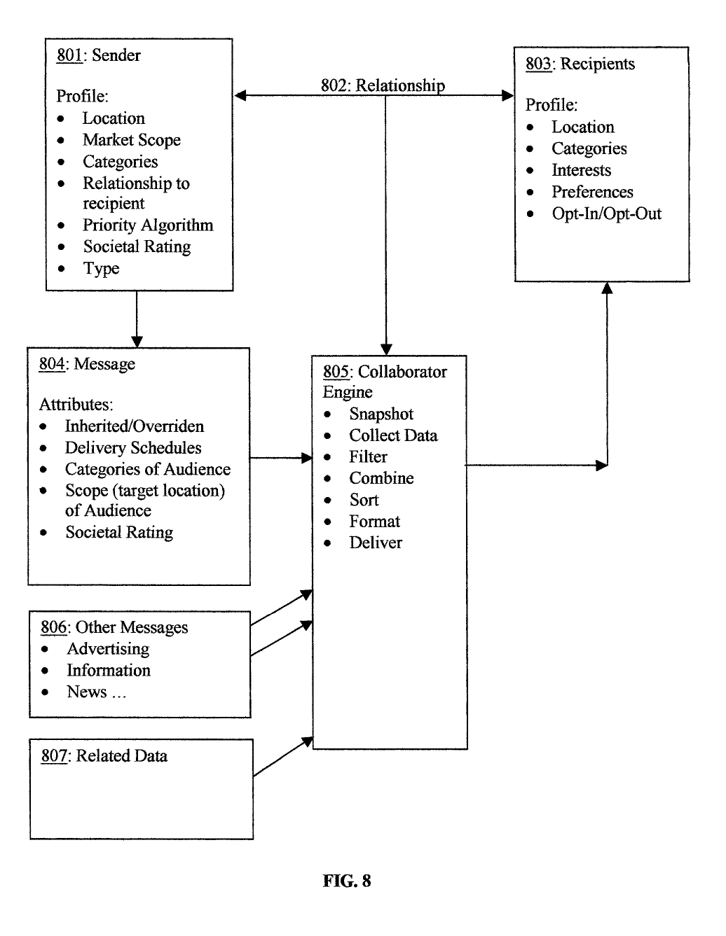

FIG. 8 demonstrates some of the various relationships and processing between senders, recipients, and the message collaborator 805. For any sender 801, the profile maintains information such as priority placement information based on the level of service between the sender and the messaging collaborator system 805. A sender can be a large conglomerate, a small entity or an individual; it is anyone or any organization maintaining a relationship 802 with any number of recipients 803 and the collaborator system. For instance, a family member may wish to deliver information to his whole family for a reunion or a party invitation to a group of friends. The Sender 801 creates one or more messages 804 that have specified attributes. The Collaborator 805 takes that message along with other messages from other such senders 806 (which may consist of paid advertising sections, free sponsorship sections, coupons, giveaways, information, news, current events sections, or any other element of information that can be summarized, formatted, and presented) and pulls any externally (or internally) related data 807 to create one comprehensive message for each recipient 803. The collaborator filters any such messaging during processing according to the recipients' preferences 803 and the rules of the collaboration system 805.

Looking at FIGS. 3 and 6 together illustrates a primary distinction between conventional mass communication messaging (FIG. 3, similarly with FIGS. 4 and 5) and the Message Collaborator (FIG. 6, similarly with FIGS. 7 and 8). Essentially, a single sender drives conventional mass communication with possible advertising from third parties where the advertising from third parties is placed and the single sender controls distribution. Whereas, a message collaboration mass communication according to one embodiment of the invention is driven by many senders, each providing its own content but sent through a common processing agent. Conventional Mass Communication is based upon the relationship between one sender (FIG. 3, 302) and it's recipients (FIG. 3, 300). The Message Collaborator provides an entirely different approach because it is based upon the cross product of many senders (FIG. 6, 602 & 603) and the many recipients of each sender (for simplicity, this has been shown as one common recipient on FIG. 6, 606). That is, the actual private relationships between each of many senders and each senders' many recipients create a matrix of relationships (i.e. in FIG. 6, each of senders 602 and 603 has it's own relationship with the recipient 606). As an illustration, in FIG. 6 if neither of senders 602 or 603 had a relationship with the recipient 606, the recipient 606 would never receive a message in the first place. In contrast, with conventional mass marketing there is only one single sender (i.e. FIG. 3, 302) with paid advertisers 307. For example, a Television station will broadcast the news regardless of which, if any, advertisers have paid for advertising. A newspaper will still deliver the newspaper full of informational content even if 20 advertisers quit paying. The actual recipients belong to the Television station or the Newspaper. The advertiser has absolutely nothing to do with whether or not the message will be delivered. He or she simply pays to participate with that message in order to reach the sender's market base. In other words, the Message Collaborator truly creates a completely personalized, unique and distinct, hybrid message for each and every recipient based upon the relationships each recipient has with each applicable sender along with all of the preferences and filters that both the sender and the recipient may define.

Returning to FIG. 8: In addition to the actual content of their message, Senders 801 have the capability to interactively determine to whom their message will be delivered by simply editing or changing its relationship maintained on the message collaborator database. What category and locality of their market to which the message will be delivered and the functionality and format of the message (whether or not it will contain hyperlinks, email links, pictures, etc.) 804.

Recipients of information 803 have the capability to personalize their own collaborative message by many different preferences such as the colors, formatting, rating of the content of their message, who is sending the elements of the message, what information and/or news clips they would like to see, whether to have a weekly, daily, or other such interval of delivery. Consequently, the collaborated message received by each individual is unique containing information geared to that individual recipients' profile.

To illustrate the explanation, one sender 801 may be a premium subscriber and accordingly be assigned a higher placement profile for any given message while another sender (also represented by 801) may have a lower placement profile where the content from the second sender would not receive as premium of placement in the collaborative message. Additionally, the sender profile can obtain information related to targeted recipient 803 categories and scope of targeted audiences. For example, a sender 801 may categorize his audience into three markets: investors, brokers, and lawyers. This sender may select a message to send to any of these categories (groups) or all of them. Similarly, the sender may have a market based in Salt Lake City, Utah, Provo, and/or Phoenix Ariz. The sender can select to send his message 804 to a selected market scope of recipients in Salt Lake City, or Provo, or Phoenix, or he can select a broader market scope such as the entire state of Utah (covering both Salt Lake City and Provo) or the United States covering all of his territories (market scope is defined in the message 804). Other information may be maintained for various content 804 from a sender, such as targeted delivery time blocks, rating standards (similar to the movie rating system of G, R, X), type of message, etc. A recipient profile 803 may define likes and dislikes, blocks from or subscriptions to various senders, preferred message receiving times, alerts such as news events, autos for sale, etc., or any other information related to the user and his preferences for receiving content or senders' information. Each profile 801/803 and their relationships 802 are dynamic by their nature. As such, any party to the relationships may change his/her settings at any moment without any prior notice.

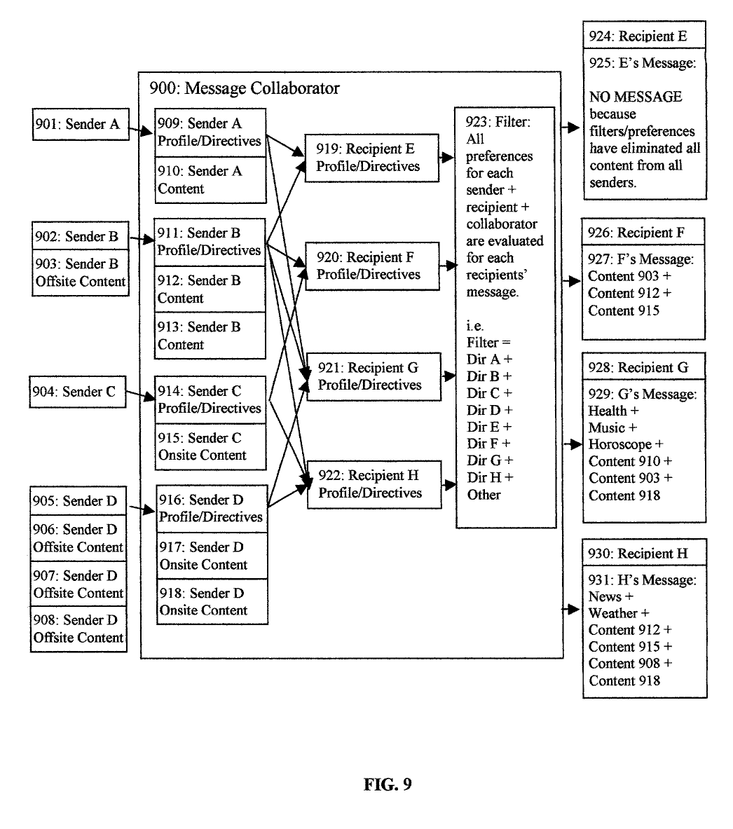

FIG. 9 demonstrates that each Recipient receives a unique, personalized message based upon his/her profile, preferences, directives, and relationships with various senders. In FIG. 9, four different senders (901, 902, 904, 905) have various relationships with four different recipients (924, 926, 928, 930). Notice that each Recipient has a completely different message (925, 927, 929, 931, respectively) with content completely dependent upon his/her profile, preferences, directives and relationships. Recipient E 924 has a relationship with senders 901 and 902 yet he receives no message because his preferences have eliminated the content from both senders. Recipient F 926 has a relationship with Sender B 902 and Sender C 904 and he receives a message 927 containing two (903, 912) of Sender B's three content elements and Sender C's only content element 915. Recipient G 928 receives the unique message 929 containing information elements (health, music, horoscope) plus Sender A's content 910, One of Sender B's content elements 903, and one of Sender D's content elements 918. Finally, Recipient H 930 receives his unique message 931 with his information elements of news and weather plus one 912 of three (903, 912, 913) content elements from Sender B 902, plus Sender C's only content element 915, plus an offsite content element 908 and an onsite content element 918 from Sender D 905. Missing data elements for any given message have been eliminated because either (a) the sender pre-filtered the message according to their selected criteria/directives, (b) the message collaborator eliminated the element/message due to derived or intentional directives, or (c) the Recipient eliminated the content element due to his/her own directives. An example of such directives would be (a) the sender categorized his recipients into age groups and selected the range 18-24, (b) the collaborator eliminated messages because a sender was spamming or a recipient was inactive or a sender or recipient directive implied that a content element was not suitable for this Recipient, or (c) the Recipient elected to only receive content suitable for general audiences and one of the senders was attempting to send adult rated material. In any case, every single message sent by the message collaborator is unique and personal to every single recipient.

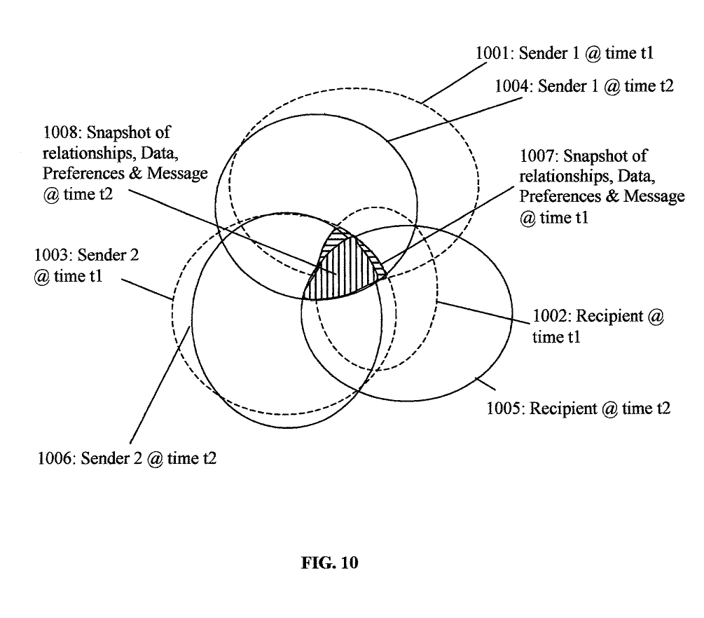

FIG. 10 provides a visualization of the dynamic nature of these relationships on a potential message with two separate snapshots at two separate instants in time. The first snapshot at time t1 1009 (indicated by a dashed line) operates on the relationships and available data between the two senders 1001, 1003 and the recipient 1002 and the second snapshot some time later at time t2 (indicated by a solid line) would operate on the relationships and data between 1004, 1005, and 1006. At any given moment in time, the profiles and preferences of various vendors and recipients overlap 1007, 1008 providing the content and rules for creating a collaborative message for that recipient 1002, 1005. However, because the relationships are constantly changing, this overlapping area changes accordingly as shown in FIG. 10 where the dashed lines are representative of the relationships between the entities at an earlier time, t1 1007. Because of the dynamic nature of the relationships, the collaborator begins working when it senses a triggering event that essentially freezes the relationship at the event moment, t2 1008, allowing the collaborator to take a snapshot of how the message should be formed.

As an illustration, the triggering event may be as simple as a day and time of the week selected by a recipient, a predetermined time established by the message collaborator, or it may be more convoluted such as a news event from a sender related to a desired event, like a sports score being posted by a sports channel subscribed to by a recipient. Alternatively, it could be a combined trigger event such as two or three elements from various relationships occurring simultaneously. For instance, upon noticing that one sender has posted content relating to a war victory (a taking of a new strategic location) and another sender has placed multiple pictures or personal videos in their content database, the collaborator may sense the relationship between these two independent senders' content and initiate a triggering event that will cause the message collaborator to combine these two sources of information into a single message for delivery to the recipient that may have indicated he wanted to receive any information related to major updates related to the war. Additionally, the snapshot may compare to the previously sent snapshot and eliminate any duplicative information so as not to send a redundant message to the recipient.

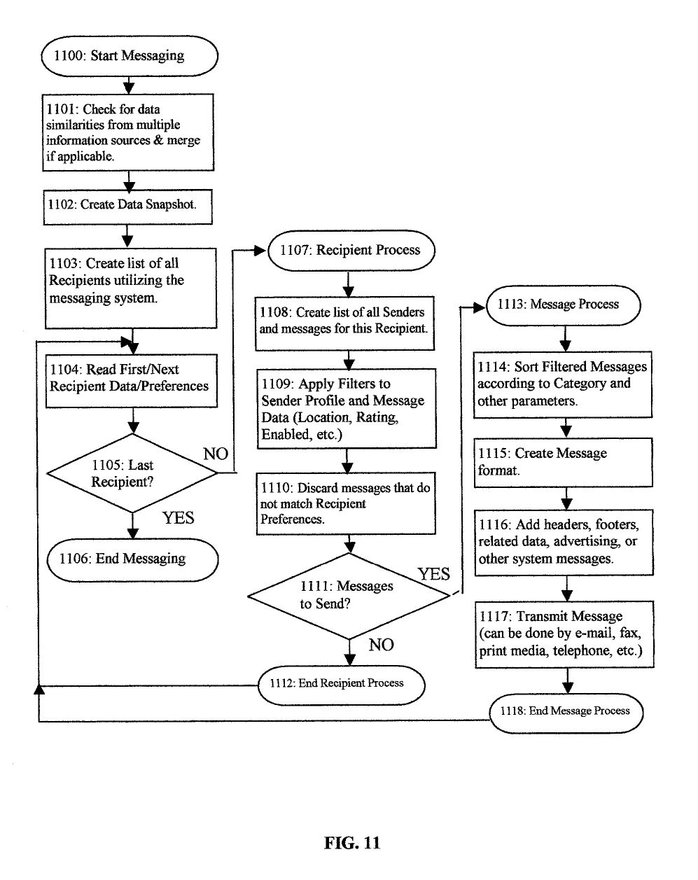

FIG. 11 demonstrates a flowchart that embodies how the invention may flow through the process of creating comprehensive and unique messages for the recipients from multiple vendors. Upon receiving a triggering event, the Message Collaborator begins its process 1100. The first step in the process is to check for any related data segments and derive/create new sub-messages 1101 based upon any event triggers and merged data from third party sources. The second step, 1102, is the capture of a snapshot of the current profiles, their relationships, and any associated messaging information. Next, it collects a list of all Recipients utilizing the Messaging System 1103. For each Recipient in the list 1104, a Recipient Process 1107 is started. A list of Senders/Messages is created according to Recipient and Sender relationships 1108. This list (1108) is filtered according to Recipient preferences including locality, rating and whether the Sender is given permission to send the message 1109. All other messages that do not conform to the preferences (1109) of the Recipient are discarded 1110. If there are remaining messages 1111, then the messaging process 1113 for this recipient begins. Otherwise, the Recipient process ends with no message being delivered 1112. In process 1113, the remaining messages are sorted according to Category, alphabet, and other criteria such as priority placement 1114. The messages are then formatted and inserted into an appropriate template 1115. Finally, appropriate headers, footers, notices are added 1116 and the message is transmitted by e-mail, fax, print media, telephone, or other medium 1117. This ends the Recipient's message process and the Collaborator moves on to the next Recipient 1104.

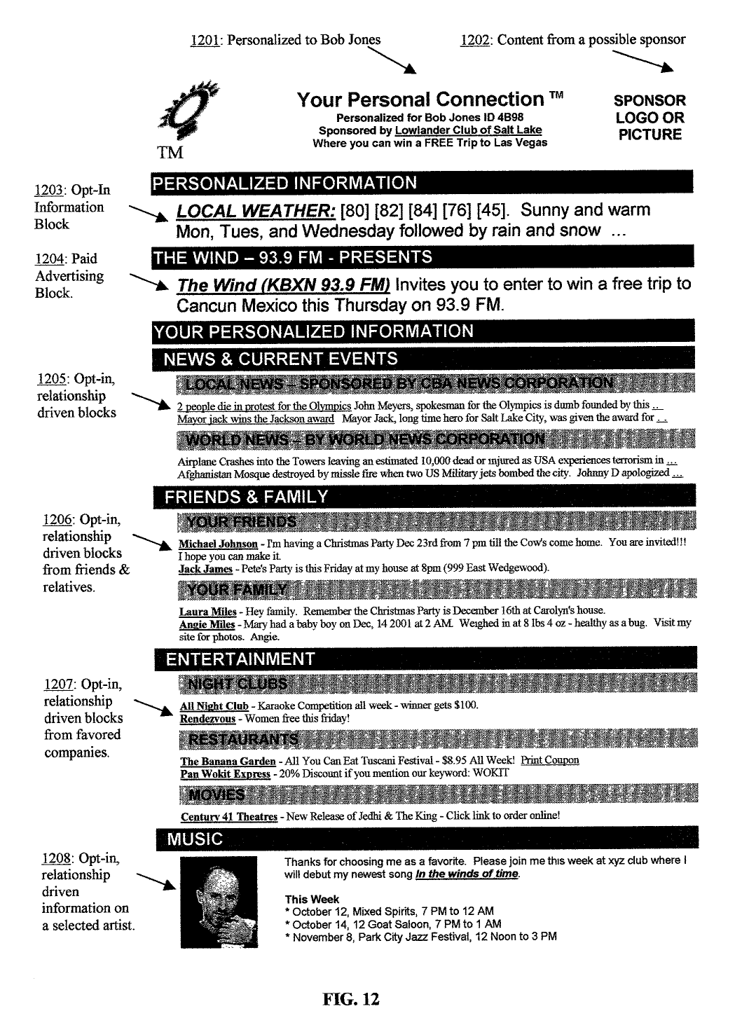

FIG. 12 illustrates an example of a simplified comprehensive message. In this example, the message contains collaborated information from large conglomerates, including news, ads and coupons as well as portions of e-mails from various individuals and corporations. The message is personalized for Bob Jones 1201 and all content (except sponsor, paid advertising, and message collaborator data) are a product of a selective, opt-in part of Bob's preferences and profile. A single sponsor for this recipient may be represented in the upper corner as well as elsewhere in the message 1202. 1203 indicates one of many possible information blocks the selected recipient has elected to receive. Such information blocks could have any informational content such as weather, religion, sports, horoscope, political information, consumer data, etc. The information blocks, like many other blocks, supports full HTML programming with graphics, links, etc. 1204 indicates a single paid advertising block. This block is driven primarily by location. It is a fully formatted message that can go out to all recipients in a given locality. Such locality is scalable from a small city location to a state, region, country, or even the entire world. 1205, 1206, and 1207 indicate relationship driven data between this recipient and various senders with which the recipient requested information. 1208 is another such block but with expanded information because the recipient is particularly interested in this artist. Any number of messages, advertising, formatting, can be displayed limited only by physical constraints and limits of requested data imposed by the Recipient. This single, comprehensive message allows the recipient to garner a plethora of information from a wide variety of sources that may or may not otherwise have a relationship.

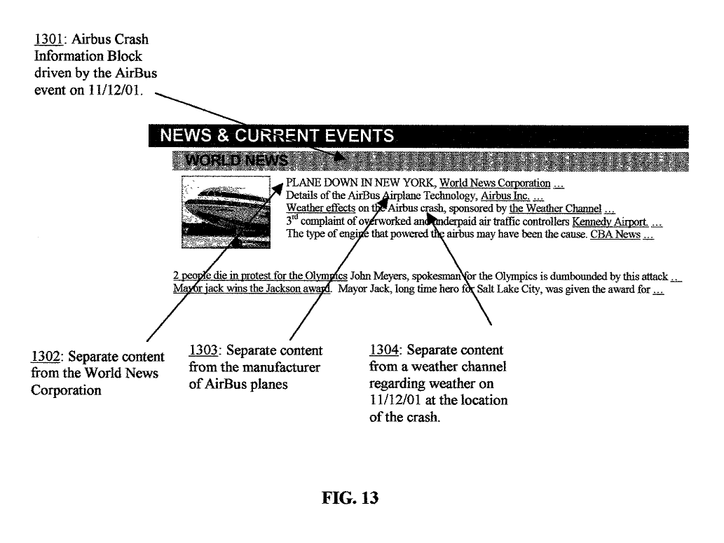

FIG. 13 demonstrates a possible “message block” that could have been included in the message illustrated in FIG. 11. This message demonstrates a simplified illustration of a single message block 1301 assembled from 5 different fictitious sources each having a different interest in the Airbus crash on Nov. 12, 2001. In this example, headlines are provided by World News Corporation 1302, schematics of the airplane layout by the Airbus corporation 1303, Weather at the time of the incident by the Weather Channel 1304, and so on. On the date of the airline crash, the Message Collaborator would, for example, sense that there was an airline crash by detecting the words “airline”, “crash”, and “Airbus” in the world news information source. Intentionally searching for the time and location of the event indicated in the article, the Message Collaborator could pull the weather for the location from a separate third party weather source. Similarly, it could pull the layout of the AirBus aircraft from the appropriate manufacturer website. The final message block, which is only a sub-element of the fully collaborated message, contains sub-elements from various sources of information.

In the foregoing specification the invention has been described with reference to specific exemplary embodiments thereof. It will, however, be evident that various modifications and changes may be made thereto without departing from the broader spirit and scope of the invention. The specification and drawings are, accordingly, to be regarded in an illustrative rather than restrictive sense. Moreover, the following claims indicate the scope of the invention, and all variations that come within the meaning and range of equivalency of the claims are to be embraced within their scope.

1. A computer implemented method comprising:
maintaining a profile for each of a plurality of senders;
Establishing a recipient preference;
Generating a single, comprehensive message comprising information according to the recipient preference and the profile for each of the plurality of senders; and
Delivering the single, comprehensive message to the recipient.

2. The method of claim 1, wherein maintaining the profile for each of the plurality of senders comprises:
receiving one or more sender preferences;
generating an action associated with a triggering event based on one or more of the one or more sender preferences;
and performing the action upon the occurrence of the triggering event.

3. The method of claim 2, wherein the triggering event is determined by the recipient preference.

4. The method of claim 2, wherein the triggering event is determined by a delivery matrix according to the profile of each of the plurality of senders and the recipient preference.

5. The method of claim 2, wherein the action comprises inserting a sender placement into the message.

6. The method of claim 5, wherein the sender placement comprises an advertisement.

7. The method of claim 5, wherein the sender placement comprises a coupon.

8. The method of claim 5, wherein the sender placement comprises a link to a sender web address.

9. The method of claim 1, wherein the recipient preference comprises one or more directives.

10. The method of claim 8 wherein one or more of the one or more directives comprises a user defined request.

11. The method of claim 1, wherein establishing the recipient preference comprises receiving one or more directives from a recipient.

12. The method of claim 1, wherein there is no independent relationship between any pair of the plurality of senders.

13. A computer implemented method comprising:
maintaining a first profile comprising a plurality of filters of a first sender;
Maintaining a second profile comprising a plurality of filters of a second sender;
Associating a first action with any combination of the plurality of filters of the first sender;
Associating a second action with any combination of the plurality of filters of the second sender;
Generating a single message according to a collaboration of the first action and the second action; and
Delivering the single message to a recipient.

14. The method of claim 13, further comprising maintaining a third profile of the recipient, wherein delivery of the single message is determined in accordance with the third profile.

15. The method of claim 13, wherein the collaboration comprises combining the first action and the second action into a third action, wherein the third action is not identifiable in the one or more directives of the first sender nor in the one or more directives of the second sender.

16. A computer implemented method comprising:
Maintaining a first relationship with a first sender;
Maintaining a second relationship with a second sender;
Maintaining a third relationship with a recipient; and
Generating a message according to a combination of the first relationship, the second relationship and the third relationship.

17. The method of claim 16, wherein each of the first, the second and the third relationship exist and operate independently of each other.

18. A computer implemented method comprising:
maintaining a relationship profile for a plurality of senders;
maintaining a relationship for a plurality of recipients;
Generating a plurality of unique, comprehensive messages, each unique, comprehensive message corresponding to one of the plurality of recipients and comprising content according to a collaboration of the relationship of the one of the plurality of recipients and the relationship profile of each of the plurality of senders; and
Delivering the unique, comprehensive message to its corresponding recipient.
